(19) United States
(12) Patent Application Publication
(10) Pub. No.: US 2023/0052313 A1
(43) Pub. Date: Feb. 16, 2023

(54) ELECTRIC STEERING ASSEMBLIES FOR COMMERCIAL VEHICLES

(71) Applicant: CHINA AUTOMOTIVE SYSTEMS, INC., Wuhan City (CN)

(72) Inventors: Haimian Cai, Ann Arbor, MI (US); Diyi Xiang, Sunnyvale, CA (US); Zhongping Zeng, Troy, MI (US)

(21) Appl. No.: 17/887,103

(22) Filed: Aug. 12, 2022

Related U.S. Application Data
(60) Provisional application No. 63/232,675, filed on Aug. 13, 2021.

(51) Int. Cl. B62D 5/04; B62D 7/20

(52) U.S. Cl. CPC B62D 5/0421; B62D 5/0454; B62D 5/0448; B62D 7/20

(57) ABSTRACT

A steering assembly for steering a vehicle in response to a steering input, the steering assembly includes an axle extending between a pair of wheels, a plurality of linkages, a primary electric drive source, and a secondary electric drive source. The plurality of linkages includes a pair of knuckles operatively coupled to the wheels, a tie rod extending between and coupled to the pair of knuckles, and a drag link attached to one of the knuckles. The primary electric drive source is operatively attached to the drag link, and moves the drag link in response to the steering input to transfer movement through the plurality of linkages to turn the wheels. The secondary electric drive source is operatively attached to one of the plurality of linkages to move the one of the plurality of linkages in response to the steering input and independently from the primary electric drive source.

### CROSS-REFERENCE TO RELATED APPLICATION

The present application claims the benefit of U.S. Provisional Patent Application No. 63/232,675, entitled “DUAL POWER STEERING SYSTEM FOR COMMERCIAL VEHICLES,” and filed on Aug. 13, 2021, the disclosure of which is incorporated by reference in its entirety.

### TECHNICAL FIELD

The present disclosure generally relates to steering assemblies for a vehicle and, more specifically, steering assemblies including two or more drive sources.

### BACKGROUND OF THE INVENTION

Traditional commercial vehicles, such as semi-trucks, use a hydraulic drive source for assisting in turning the wheels of the vehicle. The hydraulic drive source relies on a physical input from a steering column and, by increasing the pressure through a power steering pump, applies a force to the wheels of the vehicle to assist in turning the wheels. However, hydraulic drive sources are prone to failure due to the complexity and number of components. Hydraulic drive sources can fail due to, among other things, loss of hydraulic fluid due to a leak, a broken pump, or a slipped belt. Failure of a hydraulic drive source increases the difficulty of steering the vehicle, or makes steering altogether inoperable. Additionally, hydraulic drive sources require constant maintenance due to the number of components. Further, hydraulic drive sources draw power from the engine of the vehicle, leading to decreased fuel efficiency of the vehicle. Moreover, hydraulic drive sources are purely mechanical, and are therefore incompatible with automated steering applications, such as advanced driver assistance systems, as hydraulic drive sources require a physical input from a user.

### SUMMARY OF THE INVENTION

In one aspect, a steering assembly for steering a commercial vehicle in response to a steering input, the steering assembly includes a first axle extending between a first pair of wheels, a plurality of linkages, a primary electric drive source, and a secondary electric drive source. The plurality of linkages includes a first pair of knuckles operatively coupled to the first pair of wheels, a first tie rod extending between and coupled to the first pair of knuckles, and at least one drag link attached to one of the first pair of knuckles. The primary electric drive source is operatively attached to the at least one drag link and configured to move the at least one drag link in response to the steering input to transfer movement through the plurality of linkages to turn the first pair of wheels. The secondary electric drive source is operatively attached to one of the plurality of linkages and configured to independently and redundantly move the one of the plurality of linkages in response to the steering input and independently from the primary electric drive source.

Including electric drive sources in a commercial vehicle reduces the risk of failure of the steering system due to the reliability of electric drive sources and the redundant inclusion of multiple drive sources to operate the steering system in the event that one of the drive sources fails. The electric drive sources generally have fewer components than hydraulic drive sources and, therefore, require less maintenance. Additionally, as electric drive sources draw power from a battery as opposed to directly drawing power from the engine, electric drive sources increase fuel efficiency as compared to a hydraulic drive source. Electric drive sources are connectable to an electronic control unit that may control the actuation of the electric drive sources and, therefore, enable automated steering controls, such as advanced driver assistance systems. Each of the above considerations are important for owners of commercial vehicles as maintenance, fuel, and risk of accidents are significant costs of owning and operating a commercial vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a steering assembly for a vehicle including first and second drag links, and primary and secondary electric drive sources attached to the first and second drag links, according to one or more embodiments shown and described herein;

FIG. 2 schematically depicts a cross-sectional view of an exemplary electric drive source of the steering assembly of FIG. 1, according to one or more embodiments shown and described herein;

FIG. 3 schematically depicts another steering assembly including a single drag link that both the primary and secondary electric drive sources are attached to, the secondary electric drive source being a linear actuator coaxially offset from the single drag link, according to one or more embodiments shown and described herein;

FIG. 4 schematically depicts a cross-sectional view of another exemplary drive source of the steering assembly of FIG. 3, according to one or more embodiments shown and described herein;

FIG. 5A-5C schematically depict various embodiments of the exemplary drive source of FIG. 4, according to one or more embodiments shown and described herein;

FIG. 6 schematically depicts yet another steering assembly including a single drag link that both the primary and secondary electric drive sources are attached to, the secondary electric drive source being a linear actuator coaxially arranged on the single drag link, according to one or more embodiments shown and described herein;

FIG. 7 schematically depicts a cross-sectional view of another exemplary drive source for the steering assembly of FIG. 6, according to one or more embodiments shown and described herein;

FIG. 8 schematically depicts yet another steering assembly, the secondary electric drive source being a linear actuator operatively attached to a tie rod, according to one or more embodiments shown and described herein;

FIG. 9 schematically depicts yet another steering assembly including first and second drag links, the secondary electric drive source being a linear actuator operatively attached to the second drag link, according to one or more embodiments shown and described herein;

FIG. 10 schematically depicts a steering assembly including two or more steerable axles and a single drag link operatively attached to each steerable axle, the primary and secondary electric drive sources are attached to the single drag link, according to one or more embodiments shown and described herein; and

FIG. 11 schematically depicts another steering assembly including two or more steerable axles, and the secondary electric drive source is a linear actuator, according to one or more embodiments shown and described herein.

### DETAILED DESCRIPTION OF THE ENABLING EMBODIMENTS

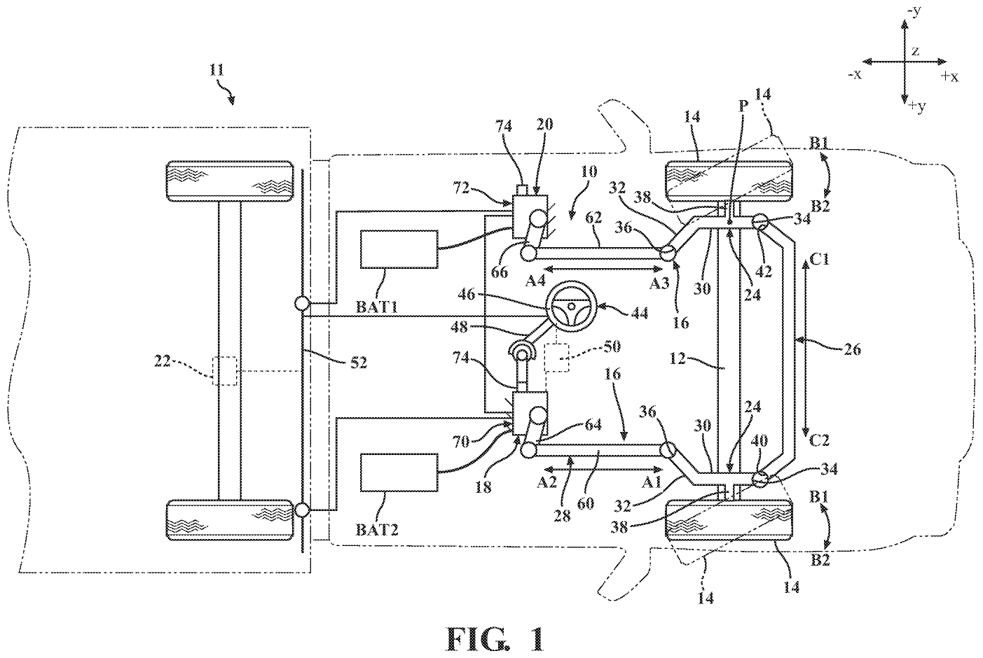

FIG. 1 generally depicts one embodiment of a steering assembly 10 for a vehicle 11. The steering assembly includes a primary electric drive source 18 and a secondary electric drive source 20 operatively coupled to a plurality of linkages 16 coupled to a pair of wheels 14 that are configured to turn the pair of wheels 14. Each of the electric drive sources 18, 20 are communicatively coupled to a vehicle communication unit (VCU) 22 capable of actuating the electric drive sources 18, 20 independently of one another, such that each electric drive source 18, 20 may be operable to turn the pair of wheels 14 of the vehicle 11 independently. Various embodiments of the steering assembly 10 and the operation of the steering assembly 10 will be described in more detail herein.

As used herein, the term “vehicle front-rear direction” refers to the forward- rearward direction of the vehicle (i.e., in the +/−X-direction as depicted). The term “vehicle width direction” refers to the cross-vehicle direction (i.e., in the +/−Y-direction as depicted), and is transverse to the vehicle front-rear direction. The “vehicle width direction” may additionally be used to refer to a left or right side of the vehicle. The term “vehicle vertical direction” refers to the upward-downward direction of the vehicle (i.e., in the +/−Z-direction as depicted).

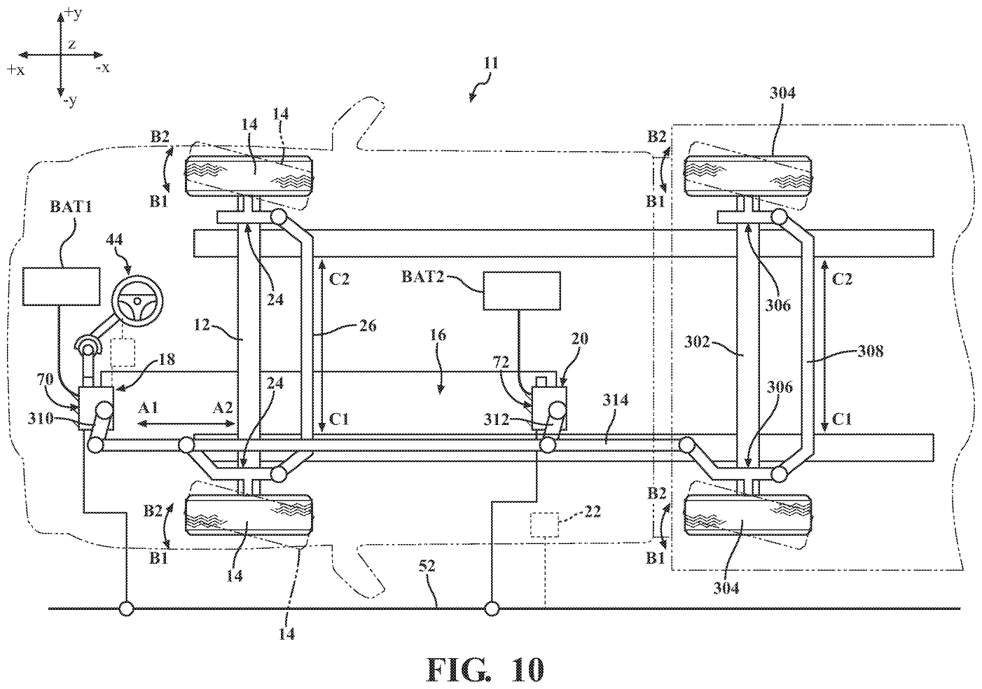

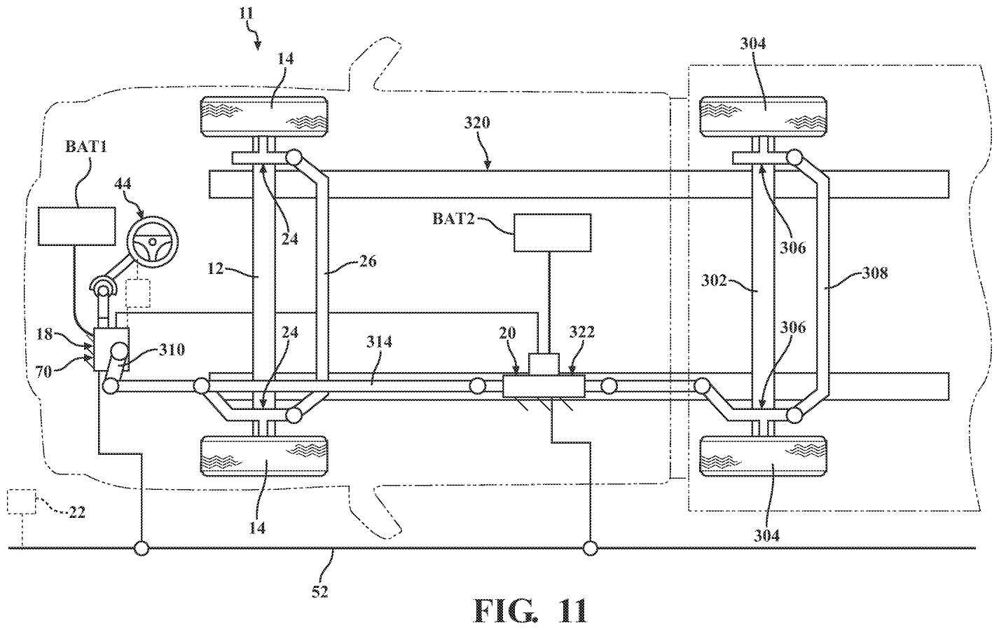

Referring now to FIGS. 1-11, various embodiments of a steering assembly 10 for a vehicle 11 are depicted. The depicted vehicle 11 is a commercial vehicle such as, for example, a semi-truck. Commercial vehicles may include a single steerable axle, as shown in FIGS. 1, 3, 6, 8, and 9, or may include two or more steerable axles, as depicted in FIGS. 10 and 11.

In each embodiment described herein, the steering assembly 10 includes a first axle 12, a first pair of steerable wheels 14 connected by the first axle 12, a plurality of linkages 16 that allow for the first pair of wheels 14 to be steered, or pivoted, a primary electric drive source 18, a secondary electric drive source 20, and a vehicle communication unit (VCU) 22. The plurality of linkages 16 includes a first pair of knuckles 24, a first tie rod 26, and at least one drag link 28. The first pair of knuckles 24 is pivotally coupled to a structure of the vehicle 11 at a pivot point P, where the vehicle 11 structure may be, for example, a suspension control arm (not shown) such that the first pair of knuckles 24 are prevented from moving in either the vehicle front-rear direction or the vehicle width direction. The first pair of knuckles 24 is operatively coupled to the first pair of wheels 14 to pivot the first pair of wheels 14 when the first pair of knuckles 24 are pivoted. Each of the first pair of knuckles 24 may include a first portion 30, a second portion 32 extending from the first portion 30, a first end 34 at an end of the first portion 30, a second end 36 opposite the first end 34 at an end of the second portion 32, and a fixing arm 38 extending from the first portion 30 to fixedly attach to one of the pair of wheels 14. The first portion 30 may be pivotally attached to the vehicle 11 structure by, for example, a ball joint at the pivot point P to allow the respective knuckle to pivot. The second portion 32 may extend obliquely from the first portion 30 to be pivotally attached to the at least one drag link 28 at the second end 36. The first portion 30 may be pivotally attached to the first tie rod 26 at the first end 34 of the respective knuckle 24.

The first tie rod 26 may extend in the vehicle width direction between and be coupled to the first pair of knuckles 24 such that the first pair of knuckles 24 rotate together. The first tie rod 26 may include a first end 40 pivotally attached to the first end 34 of one of the first pair of knuckles 24, and an opposite second end 42 pivotally attached to the first end 34 of the other of the first pair of knuckles 24. The at least one drag link 28 may extend in the vehicle front-rear direction to be attached to one of the first pair of knuckles 24 such that movement of the at least one drag link 28 in the vehicle front-rear direction causes the one of the first pair of knuckles 24 to pivot.

The pair of wheels 14 are pivotable by the first pair of knuckles 24 between a straight trajectory position and a turning trajectory position (shown in phantom). In the straight trajectory position, the pair of wheels 14 extend substantially in the vehicle front-rear direction such that the vehicle 11 may be driven in one direction. In the turning trajectory position, the pair of wheels 14 extend at least partially in the vehicle width direction, such as, for example, toward either the left or the right of the vehicle 11, such that the direction that the vehicle 11 is traveling is changed.

The primary electric drive source 18 may be operatively attached to the at least one drag link 28 such that actuation of the primary electric drive source 18 may move the at least one drag link 28 in the vehicle front-rear direction. The secondary electric drive source 20 may be operatively attached to one of the plurality of linkages 16 such that actuation of the secondary electric drive source 20 may move the one of the plurality of linkages 16. A first battery BAT1 is electrically connected to the primary electric drive source 18 and a second battery BAT2 is electrically connected to the secondary electric drive source 20 to provide a current to each of the primary electric drive source 18 and the secondary electric drive source 20 to cause the electric drive sources 18, 20 to operate. In embodiments, a single battery may be used and electrically connected to both the primary and secondary electric drive sources 18, 20. The VCU 22 may be communicatively coupled to the primary electric drive source 18 and the secondary electric drive source 20 to be configured to actuate each of the primary electric drive source 18 and the secondary electric drive source 20.

The vehicle 11 includes a steering unit 44 that may be communicatively coupled to the VCU 22 to send a steering input to the VCU 22 indicative of a desire to turn the wheels 14 of the vehicle 11. In embodiments, the steering unit 44 may be a steering wheel 46 that may be physically manipulated by a driver of the vehicle 11 to manually steer, or pivot, the wheels 14 of the vehicle 11. In embodiments, the steering assembly 10 may include a steering column 48 that extends from the steering wheel 46 to the primary electric drive source 18 to be physically attached to the primary electric drive source 18, where rotation of the steering column 48 provides the steering input to the primary electric drive source 18. In other embodiments, the steering assembly 10 may include a rotation sensor 50 communicatively coupled to the steering wheel 46 to detect rotation of the steering wheel 46, and communicatively coupled to the primary electric drive source 18 to provide the steering input to the primary electric drive source 18 in response to the detected rotation of the steering wheel 46. In further embodiments, the steering unit 44 may be an autonomous driving unit that receives signals from image sensors, such as cameras, positioned about the vehicle 11 that detect an environment. The autonomous driving unit may, in response to receiving the signals from the image sensors, automatically determine how to steer the wheels 14 of the vehicle 11 without driver input through the steering wheel 46.

The VCU 22 may be communicatively coupled to the steering unit 44 and the primary and secondary electric drive sources 18, 20 by a communication line 52, such as a CAN bus, that allows for additional components to be communicatively coupled to any of the VCU 22, the primary electric drive source 18, and the secondary electric drive source 20.

The VCU 22 may be configured to receive the steering input from the steering unit 44 and, in response, actuate each of the primary electric drive source 18 and the secondary electric drive source 20 based on the steering input to turn the first pair of wheels 14. When the VCU 22 actuates the primary electric drive source 18, the primary electric drive source 18 move the at least one drag link 28 in response to the steering input to transfer movement through the plurality of linkages 16 to turn the first pair of wheels 14. When the VCU 22 actuates the secondary electric drive source 20, the secondary electric drive source 20 moves the one of the plurality of linkages 16 in response to the steering input. The VCU 22 may separately actuate the secondary electric drive source 20 such that the secondary electric drive source 20 turns the first pair of wheels 14 independently and redundantly from the primary electric drive source 18. The independent actuation of the primary electric drive source 18 and the secondary electric drive source 20 allows for either electric drive source to control the turning of the pair of wheels 14. The redundant inclusion of two electric drive sources permits control of the turning of the pair of wheels 14 in the event that one of the electric drive sources is inoperable, for example, when one of the electric drive sources cannot transfer movement to the plurality of linkages 16.

As used herein, the term “communicatively coupled” means that coupled components are capable of exchanging data signals with one another such as, for example, electrical signals via conductive medium, electromagnetic signals via air, optical signals via optical waveguides, and the like.

Referring still to FIGS. 1-10, the primary electric drive source 18 and the secondary electric drive source 20 are each attached to one of the plurality of linkages 16, such as the first tie rod 26, the at least one drag link 28, or one of the first pair of knuckles 24. The primary electric drive source 18 and the secondary electric drive source 20 may each be different actuators in the different embodiments, such as, for example, a linear actuator or a recirculating ball motor assembly.

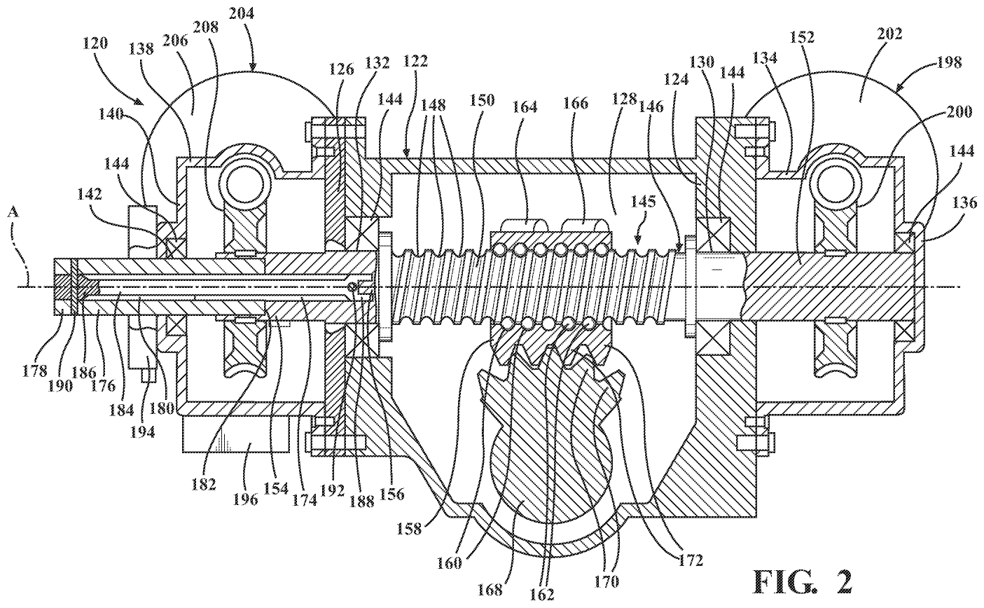

Referring now to FIGS. 1 and 2, a first exemplary embodiment of the steering assembly 10 is depicted. In the first exemplary embodiment, the at least one drag link 28 includes a first drag link 60 attached to one of the first pair of knuckles 24 and a second drag link 62 attached to the other of the first pair of knuckles 24. The steering assembly 10 further includes a first pitman arm 64 and a second pitman arm 66 each coupled to one of the respective first drag link 60 and the second drag link 62.

The primary electric drive source 18 may be an electronic recirculating ball (eRCB) assembly 70 operatively coupled to the at least one drag link 28. The first pitman arm 64 may extend between and be attached to the eRCB assembly 70 and the first drag link 60 so that the eRCB assembly 70 may move the first drag link 60 in the vehicle front-rear direction. While the primary electric drive source 18 is depicted as an eRCB assembly, it is contemplated and possible that the primary electric drive source 18 may be any actuator, such as a rotary or linear actuator, capable of moving the at least one drag link 28.

Referring now to FIG. 2, the eRCB assembly 70 may include a main housing 122, a recirculating ball gear 145, an output shaft 168 engaged with the recirculating ball gear 145 to transfer rotation from the recirculating ball gear 145 to a pitman arm, and a pair of power packs 198, 204 each engaged with the recirculating ball gear 145 to transfer rotation to the recirculating ball gear 145.

The main housing 122 may include a first side wall 124 and a second side wall 126 parallel and spaced from the first side wall 124 along an axis A to establish a chamber 128 therebetween. The first side wall 124 may include a first worm opening 130 disposed on the axis A. The second side wall 126 may include a second worm opening 132 disposed on the axis A. A first side housing 134 may be connected to the first side wall 124 around the first worm opening 130 in the main housing 122. The first side housing 134 may include a protrusion 136 opposite the first worm opening 130. A second side housing 138 may be connected to the main housing 122 through the second worm opening 132 and shares the second side wall 126 with the main housing 122. The second side housing 138 may include an input wall 140 located parallel to and opposite the second side wall 126. The input wall 140 may include an input opening 142 spaced opposite the second worm opening 132 along the axis A. A low friction bearing 144 may be disposed in each of the worm openings 130, 132 and the input opening 142 and the protrusion 136.

The recirculating ball gear may include a worm shaft 146, a first recirculating ball mechanism 164, and a second recirculating ball mechanism 166. The worm shaft 146 may extend along the axis A in the chamber 128 and through the low friction bearings 144 in each of the worm openings 130, 132 of the main housing 122. The worm shaft 146 may include a worm groove 148 that extends helically to establish a worm section 150 disposed in the chamber 128. The worm shaft 146 may include a first end section 152 that extends from the worm section 150 and into the low friction bearing 144 in the first worm opening 130 and into the first side housing 134.

The worm shaft 146 may include a second end section 154 that may include a worm end 156 adjacent the worm section 150 and extends from the worm end 156 and into the low friction bearing 144 in the second worm opening 132 and into the second side housing 138. A ball nut 158 may be disposed about a portion of the worm section 150 of the worm shaft 146 and may include ball grooves 160 that face the worm section 150 of the worm shaft 146 established helically within the ball nut 158. A plurality of ball bearings 162 that are spherical in shape are disposed in the worm grooves 148 of the worm section 150 of the worm shaft 146 and in the ball grooves 160 of the ball nut 158.

The first recirculating ball mechanism 164 may be disposed within the ball nut 158 to recirculate the plurality of ball bearings 162 once the plurality of ball bearings 162 rotate about the worm section 150 three times. The second recirculating ball mechanism 166 may be disposed adjacent to the first recirculating ball mechanism 164 within the ball nut 158 to recirculate the plurality of ball bearings 162 once the plurality of ball bearings 162 rotate about the worm section 150 three times.

The recirculating ball gear 145 may be engaged with the first pitman arm 64 by the output shaft to transfer rotation from the recirculating ball gear to the first pitman arm 64. The output shaft 168 for driving one of the pitman arms may include an output teeth set 170 disposed radially on the output shaft 168. A nut teeth set 172 extends from the ball nut 158 and engages the output teeth set 170 to move the ball nut 158 linearly along the axis A and to rotate the output shaft 168 in response to the rotation of the worm shaft 146.

The worm shaft 146 may include a worm bore 174 within the second end section 154 of the worm shaft 146 along the axis A and closed at the worm end 156 of the second end section 154 of the worm shaft 146. An input shaft 176 responsive to rotation of a steering wheel 46 extends from the second end section 154 of the worm shaft 146 along the axis A and through the low friction bearing 144 in the input opening 142 to an input end 178 and may include an input bore 180 within the input shaft 176 along the axis A that may be closed at the input end 178 of the input shaft 176. There may be a lost motion connection 182 between the input shaft 176 and the second end section 154 of the worm shaft 146 that allows relative lost motion of three to four degrees°-4° between the input shaft 176 and the worm shaft 146. A torsion bar 184 extends internally within the input bore 180 and the worm bore 174 and interconnects the input shaft 176 and the worm shaft 146 for biasing against the relative lost motion and may include a first torsion end 186 and a second torsion end 188 disposed opposite each other. A first pin 190 extends transversally to the axis A and connects the first torsion end 186 of the torsion bar 184 to the input end 178 of the input shaft 176. A second pin 192 extends transversally to the axis A and connects the second torsion end 188 of the torsion bar 184 to the worm end 156 of the second end section 154 of the worm shaft 146. A torque sensor 194 may be disposed about the input shaft 176 for measuring the torque in the input shaft 176 and communicating the torque to the electronic control unit 196.

A first power pack 198 may be in the first side housing 134 to provide a steering force in response to the steering input, and includes a first gear set 200 disposed in the first side housing 134 and in driving engagement with the first end section 152 of the worm shaft 146 and a first motor 202 supported by the first side housing 134 and connected to the first gear set 200 and responsive to an electrical signal from an ECU to rotate the worm shaft 146. In embodiments, the first gear set 200 may be a worm gear reducer, where the motor 202 is operatively attached to the worm gear reducer 200 to transfer rotation from the motor 202 to the worm gear reducer 200. A first electronic control unit (ECU) 74 may be communicatively coupled to the motor 202 to control operation of the motor 202, and transfer rotation to the worm gear reducer 200. The worm gear reducer 200 may engage the recirculating ball gear 145 to transfer rotation from the motor 202 to the recirculating ball gear 145 through the worm gear reducer 200. It is further contemplated and possible that, as used herein, a worm gear reducer may be engaged with a component having another reducer positioned therebetween, such as, for example, a planetary gear reducer, a belt reducer, or the like, that transfers rotational movement from the worm gear reducer to the component.

A second power pack 204 may provide a steering force in response to the steering input includes a second motor 206 for redundantly steering the vehicle 11 and a second gear set 208 in driving engagement with the second motor 206 for receiving mechanical input from the second motor 206. The second power pack 204 may be mounted in the second side housing 138 and may be in driving engagement with the second end section 154 of the worm shaft 146. Similarly to the other power pack 198, in embodiments, the second gear set 208 may be a worm gear reducer, where the motor 206 is operatively attached to the worm gear reducer 208 to transfer rotation from the motor 206 to the worm gear reducer 208. A second ECU 74 may be communicatively coupled to the motor 206 to control operation of the motor 206, and transfer rotation to the worm gear reducer 208. The worm gear reducer 208 may engage the recirculating ball gear 145 to transfer rotation from the motor 206 to the recirculating ball gear 145 through the worm gear reducer 208.

The worm section 150 of the worm shaft 146 may be disposed between the first power pack 198 on the first end section 152 of the worm shaft 146 and the second power pack 204 on the second end section 154 of the worm shaft 146. Placing the power pack in parallel allows for reduced complexity and a reduction in packaging footprint relative to placing the drive systems in series.

Each ECU 74 may be communicatively coupled to the VCU 22 to receive signals, such as the steering input, from the VCU 22, and actuate the respective motors to move the first pitman arm 64 and the second pitman arm 66, thereby pivoting the first pair of wheels 14. Similar to the inclusion of the primary and secondary electric drive sources 18, 20, the redundant inclusion of two power packs permits control of the turning of the pair of wheels 14 in the event that one of the power packs is inoperable.

The secondary electric drive source 20 may similarly be a secondary eRCB assembly 72. The secondary eRCB assembly 72 may be substantially similar in structure to the eRCB assembly 70 of the primary drive source 18, and, for brevity, the structure of the secondary eRCB assembly 72 will not be described again. The second pitman arm 66 may extend between and be attached to the secondary eRCB assembly 72 and the second drag link 62 so that the secondary eRCB assembly 72 may move the second drag link 62 in the vehicle front-rear direction.

The operation of the steering assembly 10 will now be described with reference to FIGS. 1 and 2. The VCU 22 may receive the steering input from the steering unit 44 indicative of a desire to turn the vehicle 11 right. In response to receiving the steering input, the VCU 22 actuates each of the primary electric drive source 18 and the secondary electric drive source 20. When the primary electric drive source 18 is actuated, the motors of the eRCB assembly 70 rotate the recirculating ball gear 145 to pivot the first pitman arm 64. The primary electric drive source 18 pivots the first pitman arm 64 to move the first drag link 60 in the direction of arrow A1 and the secondary electric drive source 20 pivots the second pitman arm 66 to move the second drag link 62 in the direction of arrow A4 opposite the direction of arrow A1. By moving the first drag link 60 in the direction of arrow A1 and the second drag link 62 in the direction of arrow A4, each of the first pair of knuckles 24 pivot in the direction of arrow B2, thereby moving the first pair of wheels 14 from the straight trajectory position to the turning trajectory position, steering the vehicle 11 to the right in the vehicle width direction.

The VCU 22 may similarly receive the steering input from the steering unit 44 indicative of a desire to turn the vehicle 11 left. In response to receiving the steering input, the VCU 22 actuates each of the primary electric drive source 18 and the secondary electric drive source 20 to move the first drag link 60 in the direction of arrow A2 and the second drag link 62 in the direction of arrow A3 opposite the direction of arrow A2. By moving the first drag link 60 in the direction of arrow A2 and the second drag link 62 in the direction of arrow A3, each of the first pair of knuckles 24 pivot in the direction of arrow B1, thereby steering the vehicle 11 to the left in the vehicle width direction.

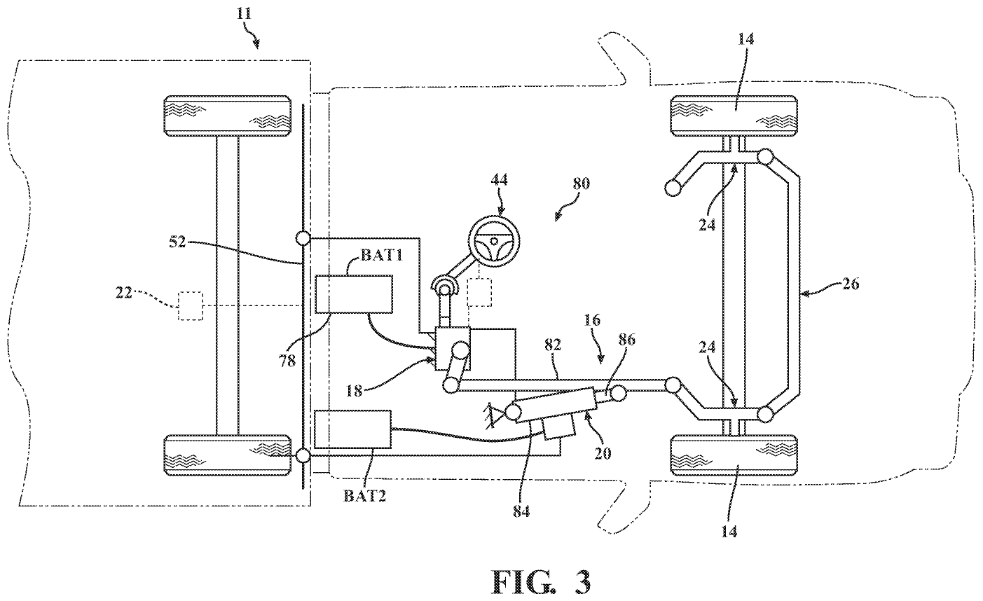

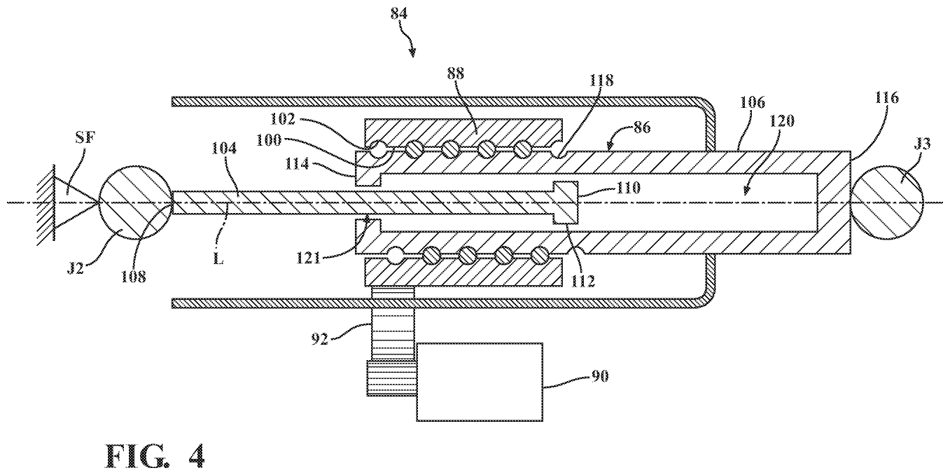

Referring now to FIGS. 3 and 4, another steering assembly 80 is depicted. The steering assembly 80 is substantially similar to the steering assembly 10 described above, including the plurality of linkages 16, the primary electric drive source 18, and the secondary electric drive source 20. Accordingly, like structure will not be described again for brevity. The steering assembly 80 differs in that the at least one drag link 28 includes a single drag link 82, and the secondary electric drive source 20 is a linear actuator 84 operatively attached to the drag link 82.

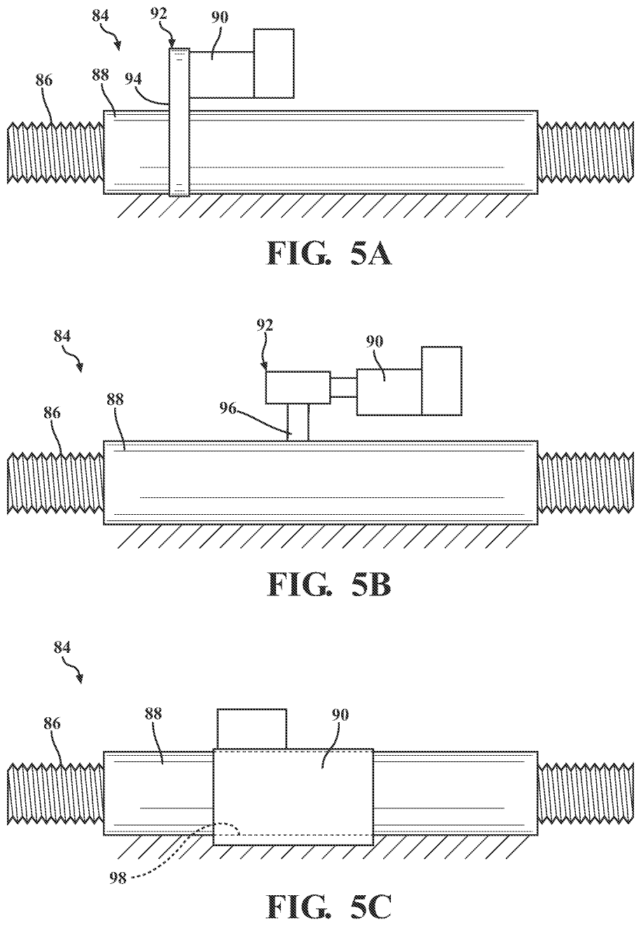

The linear actuator 84 may include a screw shaft 86, a nut 88 engaged with the screw shaft, a motor 90, and a transfer mechanism 92 for transferring rotation from the motor 90 to the nut 88. Referring briefly to FIG. 5A, in embodiments, the transfer mechanism 92 may be a belt 94 extending from the motor 90 to the nut 88. Referring briefly to FIG. 5B, in other embodiments, the transfer mechanism 92 may be a worm gear reducer 96 extending from the motor 90 to the nut 88. In either embodiment, the transfer mechanism 92 may be operatively attached to the motor 90 and engaged with the nut 88 such that rotation of the motor 90 transfers rotation to the nut 88 through the transfer mechanism 92. However, it is contemplated and possible that the transfer mechanism 92 may be any known mechanism for transferring rotation from the motor 90 to the nut 88. Referring briefly to FIG. 5C, the motor 90 may be concentrically arranged about the nut 88 to be directly attached to the nut 88. In such embodiments, the motor 90 may be a motor that defines a bore 98 extending therethrough that the nut 88 may be positioned within to directly couple the nut 88 to the motor 90. The motor 90 may be, for example, a hollow bore motor, a frameless motor, or the like.

Referring to FIG. 4, the nut 88 may define a bore 100 extending therethrough, and include an internally threaded surface 102 positioned in the bore 100 and extending at least partially along a length of the nut 88. The screw shaft 86 may include a piston 104 and a body 106, and may define a linear axis L extending along a length of the screw shaft 86. The piston 104 may include a first end 108, an opposite second end 110, and a head 112 at the second end 110. The body 106 may include a first end 114, an opposite second end 116, and an externally threaded surface 118 extending at least partially between the first end 114 and the second end 116. The body 106 may define a cavity 120 and an opening 121 positioned at the first end 114 that extends into the cavity 120 to permit the piston 104 to be partially positioned within the cavity 120 and extend out of the body 106 through the opening 121. The head 112 of the piston 104 may be positioned within the cavity 120 and be sized to be larger than the opening 121 to restrict the piston 104 from passing through the opening 121.

The screw shaft 86 may be positioned within the bore 100 of the nut 88, with the externally threaded surface 118 engaged with the internally threaded surface 102 of the nut 88 such that rotation of the nut 88 by the motor 90 moves the screw shaft 86 along the linear axis L. The first end 108 of the piston 104 may be pivotally attached to a stationary feature SF of the vehicle 11, such as, for example, a vehicle frame, by a ball joint J2, and the second end of the screw shaft 86 may be pivotally attached to the drag link 82 by another ball joint J3. Each of the ball joints J2, J3 allow the screw shaft 86 to pivot and remain attached to the one of the plurality of linkages 16 while the one of the plurality of linkages 16 is moving.

Referring again to FIG. 3, the linear actuator 84 may be positioned to be extendable substantially in the vehicle front-rear direction. The linear actuator 84 may be positioned to be coaxially offset from the drag link 82 and attached to the drag link 82 so that, when the motor 90 is actuated, the nut 88 rotates to move the screw shaft 86 along the linear axis L to move the drag link 82 in either of the direction of arrow A1 or the direction of arrow A2. The linear actuator 84 may operate similarly to the secondary eRCB assembly 72 of the steering assembly 10 described above, operating independently from the primary eRCB assembly 70 and in response to a steering input to steer the first pair of wheels 14.

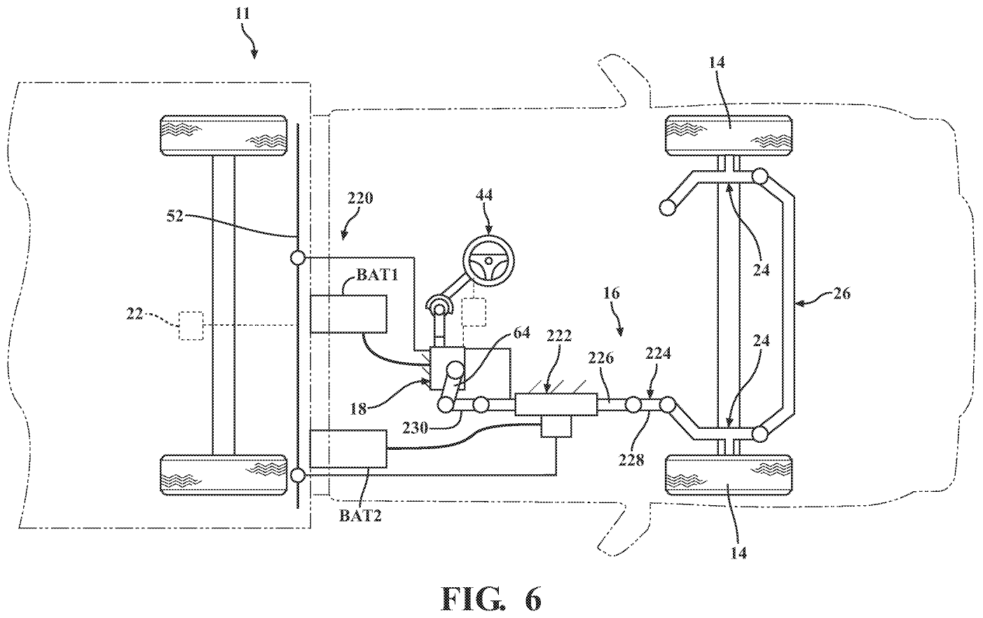

Referring now to FIG. 6, another steering assembly 220 is depicted. The steering assembly 220 is substantially similar to the steering assemblies 10, 80 described above and like structure will not be described again for brevity. The steering assembly 220 differs in that a linear actuator 222 is coaxially arranged about a drag link 224. In such embodiments, the linear actuator 222 extends along a length of the drag link 224. The drag link 224 may be segmented with a screw shaft 226 of the linear actuator 222 positioned between a first portion 228 and a second portion 230 of the segmented drag link 224, the second portion 230 being spaced apart from the first portion 228.

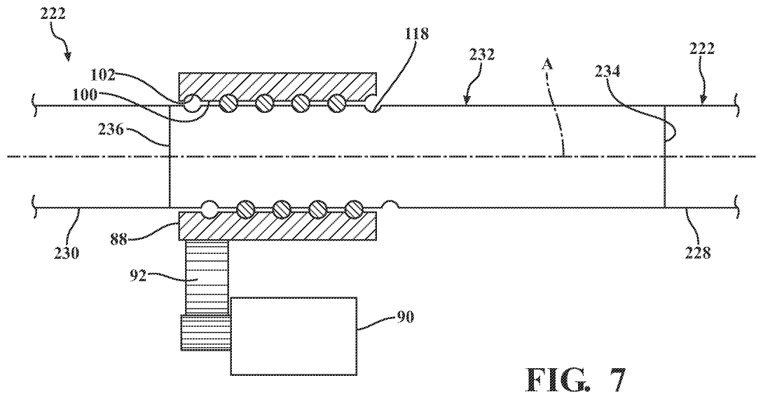

Referring to FIG. 7, in the depicted embodiment, the linear actuator 222 may include substantially the same structure as the linear actuator 84 described above, and like structure will not be described again for brevity. The linear actuator 222 may differ in that the linear actuator 222 may include a screw shaft 232 without a piston. The screw shaft 232 may include a first end 234 and an opposite second end 236, the first end 234 being fixedly coupled to the first portion 228 of the drag link 224 and the second end 236 being fixedly coupled to the second portion 230 of the drag link 224. In such embodiment, actuation of the motor causes the screw shaft 232 to axially translate along the linear axis L. The nut 88 and motor 90 may be fixedly attached to a rigid structure of the vehicle 11 so that the nut 88 and motor 90 move the screw shaft 232 relative to the rigid structure. Accordingly, the linear actuator 222 may move the drag link 224 along the linear axis L relative to the rigid structure.

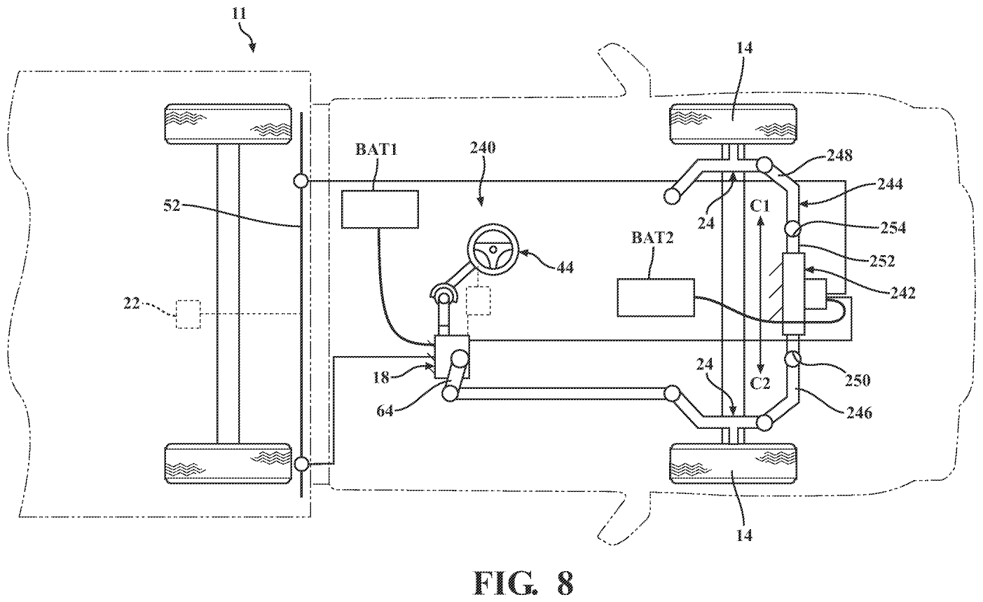

Referring now to FIG. 8, another steering assembly 240 is depicted. The steering assembly 240 differs from the steering assembly 220 described above in that the steering assembly 240 includes a linear actuator 242 operatively attached to a tie rod 244 to be configured to move the tie rod 244 in the directions of arrow C1 and C2. In some embodiments, the linear actuator 242 may be similar in structure to the linear actuator 84 of the steering assembly 80 of FIG. 3, the linear actuator 242 being coaxially offset from the tie rod 244. In other embodiments, the linear actuator 242 may be similar in structure to the linear actuator 222 of FIG. 7, the linear actuator 242 being coaxially arranged about the tie rod 244. In such embodiments, the tie rod 244 may be segmented into a first portion 246 and a second portion 248 spaced apart from the first portion 246. The linear actuator 242 may be positioned between the first portion 246 and the second portion 248, with a first end 250 of a screw shaft 252 fixedly coupled to the first portion 246 and a second end 254 fixedly coupled to the second portion 248. In any of the embodiments, the linear actuator 242 may be actuated to move the tie rod 244 in the directions of arrow C1 and C2, thereby pivoting the first pair of wheels 14 between the straight trajectory position and the turning trajectory position.

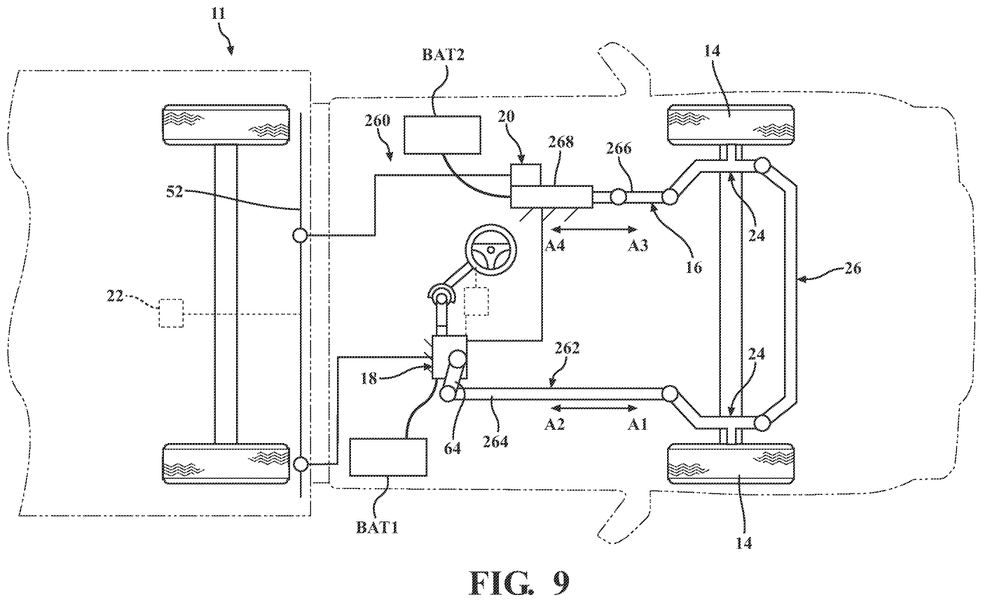

Referring now to FIG. 9, another steering assembly 260 is depicted. The steering assembly differs from the steering assemblies 10, 80, 220, 240 described above, and like structure will not be described again for brevity. At least one drag link 262 of the steering assembly 260 includes a first drag link 264 attached to one of the first pair of knuckles 24, and a second drag link 266 attached to the other of the first pair of knuckles 24. A linear actuator 268 may be operatively attached to the second drag link 266 to be configured to move the second drag link 266 in the directions of arrows A3 and A4. In some embodiments, the linear actuator 268 may be the linear actuator 84 of the steering assembly 80 of FIG. 3, or the linear actuator 222 of the steering assembly 220 of FIG. 6. In any of the embodiments, the linear actuator 268 may be coaxially arranged about the second drag link 266, or coaxially offset from the second drag link 266. In any of the embodiments, the linear actuator 268 may be actuated to move the second drag link 266 in the directions of arrows A3 and A4, thereby pivoting the first pair of wheels 14 between the straight trajectory position and the turning trajectory position.

Referring now to FIG. 10, another steering assembly 300 is depicted having two steerable pairs of wheels. However, it is contemplated and possible that the steering assembly 300 has more than two steerable pairs of wheels, such as three, four, or more than four. The steering assembly 300 includes a second axle 302, a second pair of wheels 304 connected by the second axle 302, and the plurality of linkages 16 further includes a second pair of knuckles 306 operatively coupled to the second pair of wheels 304, a second tie rod 308 extending between and coupled to the second pair of knuckles 306, and a first pitman arm 310 and a second pitman arm 312 each attached to the at least one drag link 28. The at least one drag link 28 may include a single drag link 314 attached to both one of the first pair of knuckles 24 and one of the second pair of knuckles 306, and the secondary electric drive source 20 may be operatively attached to the drag link 314.

The primary electric drive source 18 and the secondary electric drive source 20 may each be an eRCB assembly operatively attached to the drag link 314. The primary electric drive source 18 may be attached to the drag link 314 by the first pitman arm 310, and the secondary electric drive source 20 may be attached to the drag link 314 by the second pitman arm 312. Each of the primary electric drive source 18 and the secondary electric drive source 20 may be actuated to pivot the respective first and second pitman arms 310, 312 to move the drag link 314 in the directions of arrows A1 and A2. The movement of the drag link 314 pivots both the first pair of knuckles 24 and the second pair of knuckles 306 to pivot both the first pair of wheels 14 and the second pair of wheels 304 between the straight trajectory position and the turning trajectory position.

Referring now to FIG. 11, another steering assembly 320 is depicted. The steering assembly 320 is substantially similar to the steering assembly 300 of FIG. 10, and like structure will not be described again for brevity. The steering assembly 320 differs in that the secondary electric drive source 20 is a linear actuator 322 operatively attached to the drag link 314. The linear actuator 322 may be either of the linear actuator 84 of FIG. 3 coaxially offset from the drag link 314, or the linear actuator 222 of FIG. 6 coaxially arranged about the drag link 314. In any of the embodiments, the linear actuator 322 may be actuated to move the drag link 314 in the directions of arrows A1 and A2, thereby pivoting the first pair of wheels 14 and the second pair of wheels 304 between the straight trajectory position and the turning trajectory position.

In any of the embodiments discussed herein, it should be understood that the redundancy of including a secondary electric drive source and the further redundancy of including an electric recirculating ball motor assembly having two motors to move the plurality of linkages of the steering assemblies allows each of the steering assemblies to be operable in the event that one of the primary electric drive source and the secondary electric drive source are inoperable, and to further be operable in the event that one of the motors of the electric recirculating ball motor assembly is inoperable. Accordingly, the steering assemblies disclosed herein provide a high degree of reliability for steering a vehicle, and reduce the risk of accidents that occur due to faulty steering assemblies.

For the purposes of defining and describing the present invention, it is noted that the term “attached” is used herein to describe a physical connection between two components, such as, for example, the coupling between the primary drive source and the pitman arm. However, as used herein, two components may be “attached” by one or more components disposed therebetween, such as, for example, the primary drive source being attached to the drag link by the pitman arm disposed therebetween.

It is noted that the term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A steering assembly for steering a vehicle in response to a steering input, the steering assembly comprising:
a first axle extending between a first pair of wheels;
a plurality of linkages comprising:
a first pair of knuckles operatively coupled to the first pair of wheels;
a first tie rod extending between and coupled to the first pair of knuckles;
at least one drag link attached to one of the first pair of knuckles;
a primary electric drive source operatively attached to the at least one drag link and configured to move the at least one drag link in response to the steering input to transfer movement through the plurality of linkages to turn the first pair of wheels; and
a secondary electric drive source operatively attached to one of the plurality of linkages and configured to independently and redundantly move the one of the plurality of linkages in response to the steering input.

2. The steering assembly of claim 1, further comprising a vehicle communication unit (VCU) communicatively coupled to the primary electric drive source and the second electric drive source and configured to receive the steering input and actuate each of the primary electric drive source and the secondary electric drive source based on the steering input to turn the first pair of wheels.

3. The steering assembly of claim 1, wherein the primary electric drive source is an electronic recirculating ball (eRCB) assembly operatively coupled to the at least one drag link by at least one pitman arm.

4. The steering assembly of claim 3, wherein the eRCB assembly comprises:
a recirculating ball gear engaged with the at least one pitman arm to transfer rotation to the pitman arm; and
a pair of power packs engaged with the recirculating ball gear to transfer rotation to the recirculating ball gear, each of the pair of power packs comprises:
a worm gear reducer;
a motor operatively attached to the worm gear reducer to transfer rotation to the worm gear reducer; and
an ECU communicatively coupled to the motor to control operation of the motor, the worm gear reducer engages the recirculating ball gear to transfer rotation to the recirculating ball gear.

5. The steering assembly of claim 1, wherein the secondary electric drive source is an electronic recirculating ball (eRCB) assembly operatively coupled to the at least one drag link by at least one pitman arm.

6. The steering assembly of claim 5, wherein:
the at least one drag link comprises a first drag link attached to one of the pair of knuckles and a second drag link attached to the other of the pair of knuckles; and
the primary electric drive source is operatively attached to the first drag link by a first pitman arm, and the secondary electric drive source is operatively attached to the second drag link by a second pitman arm.

7. The steering assembly of claim 1, wherein the secondary electric drive source is a linear actuator.

8. The steering assembly of claim 7, wherein the secondary electric drive source is coaxially arranged about the at least one drag link.

9. The steering assembly of claim 7, wherein the secondary electric drive source is coaxially offset from the at least one drag link.

10. The steering assembly of claim 7, wherein the secondary electric drive source is attached to the at least one drag link.

11. The steering assembly of claim 7, wherein the secondary electric drive source is attached to the tie rod.

12. The steering assembly of claim 7, wherein the secondary electric drive source is attached to the other of the pair of knuckles.

13. The steering assembly of claim 7, wherein the linear actuator comprises:
a screw shaft attached to one of the plurality of linkages and defining a linear axis;
a nut coaxially positioned about the linear axis and engaged with the screw shaft;
a motor positioned offset from the linear axis; and
a belt extending from the motor to the nut to transfer rotation from the motor to the nut;
wherein rotation of the nut moves the screw shaft along the linear axis.

14. The steering assembly of claim 7, wherein the linear actuator comprises:
a screw shaft attached to one of the plurality of linkages and defining a linear axis;
a nut coaxially positioned about the linear axis and engaged with the screw shaft;
a motor positioned offset from the linear axis; and
a worm gear reducer extending from the motor to the nut to transfer rotation from the motor to the nut;
wherein rotation of the nut moves the screw shaft along the linear axis.

15. The steering assembly of claim 7, wherein the linear actuator comprises:
a screw shaft attached to one of the plurality of linkages and defining a linear axis;
a nut coaxially positioned about the linear axis and engaged with the screw shaft;
a motor positioned coaxial with the linear axis and operatively attached to the nut to transfer rotation to the nut;
wherein rotation of the nut moves the screw shaft along the linear axis.

16. The steering assembly of claim 1, wherein the steering assembly further comprises a steering column extending to the primary electric drive source to be physically attached to the primary electric drive source, and rotation of the steering column provides the steering input to the primary electric drive source.

17. The steering assembly of claim 1, further comprising a steering wheel and a rotation sensor communicatively coupled to the steering wheel to detect rotation of the steering wheel, the rotation sensor is communicatively coupled to the primary electric drive source to provide the steering input to the primary electric drive source in response to the detected rotation of the steering wheel.

18. The steering assembly of claim 1, further comprising:
a second axle extending between a second pair of wheels;
wherein the plurality of linkages further comprises:
a second pair of knuckles operatively coupled to the second pair of wheels, the at least one drag link is attached to one of the second pair of knuckles;
a second tie rod extending between and coupled to the second pair of knuckles; and
the secondary electric drive source is operatively attached to the at least one drag link.

19. The steering assembly of claim 18, wherein:
the plurality of linkages further comprises a first pitman arm and a second pitman arm each attached to the at least one drag link;
the primary electric drive source is an eRCB assembly operatively attached to the at least one drag link by the first pitman arm; and
the secondary electric drive source is an eRCB assembly operatively attached to the at least one drag link by the second pitman arm.

20. The steering assembly of claim 18, wherein:
the plurality of linkages further comprises a first pitman arm attached to the at least one drag link;
the primary electric drive source is an eRCB assembly operatively attached to the at least one drag link by the first pitman arm; and
the secondary electric drive source is a linear actuator operatively attached to the at least one drag link.
